(19) United States
(12) Patent Application Publication
(10) Pub. No.: US 2007/0134520 A1
(43) Pub. Date: Jun. 14, 2007

(54) METHOD AND APPARATUS OF GENERATING ELECTRIC POWER

(75) Inventors: Tatsuo Shimomura, Fujisawa-shi (JP); Makoto Komatsu, Fujisawa-shi (JP); Masanori Adachi, Fujisawa-shi (JP); Osamu Tsutsumi, Fujisawa-shi (JP); Kazuyoshi Takeda, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: EBARA CORPORATION, Ohta-ku (JP)

(21) Appl. No.: 11/556,883

(22) Filed: Nov. 6, 2006

(30) Foreign Application Priority Data
Mar. 29, 2004 (JP) 2004-096582
Mar. 25, 2005 (JP) 2005-088158

(51) Int. Cl. H01M 8/16

(52) U.S. Cl. 429/2; 429/43; 429/13

(57) ABSTRACT

Power generation is performed by immobilizing an electron mediator having a standard electrode potential (E₀′) at pH 7 in the range of −0.13 V to −0.28 V to one of a pair of electrodes to form an anode 1 and electrically connecting the other electrode as a cathode 3 to the anode 1 to form a closed circuit, bringing the anode 1 into contact with microorganisms capable of growing under anaerobic conditions and a solution or suspension 4 containing an organic substance to advance the oxidation reaction by microorganisms using the organic substance as an electron donor, separating the cathode 3 and the solution or suspension through an electrolyte membrane 2 to advance the reduction reaction using oxygen as an electron acceptor at the cathode, and accelerating the oxidation reaction in the biological system.

### BACKGROUND OF THE INVENTION

1. Field of the Invention

This invention relates to a method and apparatus for generating electric power, in particular, a technique of performing power generation by utilizing an organic substance such as waste water, waste liquor, nightsoil, food waste and other organic wastes and sludge or their decomposed products as a substrate and separating the oxidation-reduction reaction between the substrate and the oxygen in air into the oxidation reaction by an anaerobic microorganism and the reduction reaction of oxygen.

2. Prior Art

As the method of decomposing waste water, waste liquor, nightsoil, food waste, other organic wastes or sludge (hereinafter referred to as “water-containing organic substance”) to take out energy, a method of producing methane and the like by an anaerobic digestion method including methane generation to utilize them for performing power generation, a microbial fuel cell method of directly taking electricity out of the anaerobic respiration reaction of microorganisms and the like have been devised.

However, the method of producing methane, ethane, hydrogen and the like by the anaerobic digestion method including methane generation to perform power generation by utilizing them requires two steps of a substance production process by microorganisms and a power generation process utilizing the product as a fuel, and thus there is a problem of poor energy efficiency and complication of an apparatus used.

On the other hand, a method of donating electrons from an electron donor in the neighborhood of an anode to an electron acceptor (mainly dissolved oxygen) in the neighborhood of a cathode by connecting the anode to the cathode is reported (Japanese Patent Public Disclosures (KOKAI) 2000-133327; 2000-133326; and 2002-520032). In a method described in these patent publications, the cathode is placed in water, and accordingly it is highly possible for the diffusion rate of the dissolved oxygen in water to rate-limit the whole reaction. In other words, the reduction reaction of the dissolved oxygen in water is rate-limited by the diffusion rate of the oxygen in water, and thus the quantity of electric current per unit surface area of an electrode without stirring comes to a maximum value of 20 μA/cm² irrespective of the overvoltage. Since this value is remarkably smaller than the value when the oxygen in air is used (about 300 mA/cm² at an overvoltage of 200 mV), it is expected to rate-limit the oxidation of the water-containing substance and the power generation.

Further, in another example, a method of efficiently taking out electrons by adding an electron mediator to microorganisms in a medium and maintain the microorganisms in a starving state is proposed (U.S. Pat. No. 4,652,501), and according to this patent, it is described that an oxygen electrode or an air electrode can be used as a cathode. However, no description of a concrete structure of the apparatus and no example is given in this patent in the case of using an air electrode, and the air electrode is not disclosed as the means to solve the problem in such a manner for a person skilled in the art to carry out the invention.

Furthermore, in another example, as a method of producing an enzyme electrode, a method of immobilizing a redox compound for an electron mediator of an oxidation reduction enzyme on to an electrode is proposed (Japanese Patent Public Disclosure (KOKAI) No. S57-69667). In this patent publication, a method of mixing an electron mediator with a photo-cross-linkable resin, coating the resulting mixture on the surface of the electrode and thereafter irradiating the coated surface with a mercury lamp to immobilize the electron mediator is described. However, according to this method, the electron mediator is inclusively immobilized with the resin, and thus the portion of the electron mediator embedded inside the resin layer cannot be efficiently brought into contact with the enzyme of microorganisms or an extracellularly released electron medium (for example, a menaquinone derivative). Therefore, in the case of utilizing the method disclosed in this patent publication for the power generation method utilizing an organic substance which is the object of this invention, the current density per electrode surface cannot be increased, and thus there has been a difficulty in obtaining a practical power generating rate.

As a microbial fuel cell technique of utilizing an electron mediator, a method of using a water-containing substance or its decomposed product as a substrate and separating the oxidation-reduction reaction between the substrate and oxygen into an oxidation reaction by anaerobic microorganisms and a reduction reaction of oxygen to perform power generation is proposed (Japanese Patent Public Disclosure (KOKAI) No. 2002-520032; Roller et al., 1984, Journal of Chemical Technology and Biotechnology 334B: 3-12, Bond et al., 2002, SCIENCE 295: 483-485; and Park et al., 2000, Biotechnology Letters 22: 1301-1304). However, the standard electrode potentials of the electron mediators used in these patent publications and references do not overlap with the standard electrode potentials of the final electron acceptor substances of anaerobic microorganisms used in the conventional microbial fuel cell reaction, and thus there is a problem of forming no effective potential cascade. For example, the electron mediators and their standard electrode potentials heretofore proposed are as shown in the following Table 1.

TABLE 1
Standard Electrode Potentials
of Various Electron Mediators

| | | Standard Electrode Potential |
|---|---|---|
| | Electron Mediator | E₀′ (V) |
| A | Thionine | +0.064 |
| B | Brilliant Cresyl Blue | +0.047 |
| C | NAD⁺ | −0.32 |
| D | Neutral Red | −0.325 |
| E | Benzyl Viologen | −0.36 |
| F | Methyl Viologen | −0.36 |
| G | Ethyl Viologen | −0.45 |

On the other hand, the standard electrode potentials of sulfur and iron of the final electron acceptor substances of sulfur-reducing bacteria and iron (III) oxide-reducing bacteria which are anaerobic microorganisms to be used in the conventional microbial fuel cell reaction are as shown in the following Table 2.

TABLE 2
Standard Electrode Potentials of Final Electron
Acceptor Substance of Microorganisms

| Final Electron | Standard Electrode Potential |
|---|---|
| Accepting Reaction | E₀′ (V) |
| O₂/H₂O | +0.82 |
| Fe(III)/Fe(II) | +0.20 |
| S(O)/H₂S | −0.28 |

It can be understood from Table 2 that the terminal enzyme (sulfur-reducing enzyme) of the electron transmitting system possessed by the sulfur-reducing bacteria can reduce a substance having a standard electrode potential of −0.28 V while the terminal enzyme (iron (III) oxide-reducing enzyme) of the electron transmitting system possessed by the iron (III) oxide-reducing bacteria can reduce a substance having a standard electrode potential of +0.20 V. These terminal reducing enzymes are present in the outer membrane and the periplasm of a microorganism and can reduce iron (III) oxide and sulfur of 0 valence outside the microbial body, and accordingly can be effective catalysts for efficient to generate electric power. However, the standard electrode potentials of the electron mediators A to G proposed theretofore are all lower than the standard electrode potential for iron reduction as shown in Table 1, and thus an effective potential cascade cannot be formed between an iron (III) oxide-reducing enzyme, an electron mediator and an anode. Similarly, since the electron mediators C to G in Table 1 have lower standard electrode potentials than the standard electrode potential for sulfur reduction, an effective potential cascade cannot be formed between a sulfur-reducing enzyme, an electron mediator and an anode. The electron mediators A and B in Table 1 have higher standard electrode potentials than the standard electrode potential for sulfur reduction, and thus theoretically the reduction by the sulfur reducing enzyme is possible but the potential difference is 0.3 V or more and there is a high possibility of difficulty in biological electron transmission. In addition, in order to increase the efficiency of power, it is required to cause the largest possible potential difference for the oxygen reduction reaction at the cathode but due to the high potential of the electron mediator, potential differences of 0.3 V or more are lost and cause decreased energy production.

Then, a trial of increasing the electron transmission efficiency by adding anthraquione-2,6-disulphonic acid (AQ-2,6-DS) to the anode compartment in a microbial fuel cell system using sulfur-reducing bacteria has been proposed (Roller et al., 1984, Journal of Chemical Technology and Biotechnology 334B: 3-12). The standard electrode potential of AQ-2,6-DS is −0.185 V and thus AQ-2,6-DS is thought a suitable substance for forming an effective potential cascade between a sulfur reducing enzyme and an electron mediator. In the proposed system, however, AQ-2,6-DS is merely added to the liquid phase and is not immobilized on to the anode (oxidation electrode), and thus the reactivity of AQ-2,6-DS with the anode is low and its addition effect remains an increase in the current value by 24%. Further in the case of continuously generating power, there is a problem such that the electron mediator is discharged together with the substrate liquor out of the system when the substrate solution in the anode compartment is renewed and the addition of the electron mediator has to be continued at all times.

A trial of immobilizing Neutral Red on to an anode with the use of an amide bonding is also proposed (Park et al., 2000, Biotechnology Letters 22: 1301-1304). According to this proposal, in introducing a carboxyl group with the oxidation of a graphite electrode and reacting the carboxyl group with Neutral Red in the presence of dicyclohexylcarbodiimide to form an amide bonding, it is thought that the carboxyl group is bonded to the secondary amine of the 9-position shown by an arrow in the following structural formula.

[Formula 1]

### Structural Formula of Neutral Red

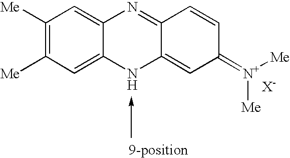

Carboxyl group is bonded to the site of an arrow.

However, by chemically modifying the secondary amine on 9-position, the standard electrode potential of Neutral Red can greatly vary. In fact, the peak of the current value in cyclic voltammetry of the Neutral Red bonded to the graphite recognized in around −0.42 V is lowered by about 0.1 V from the standard electrode potential of −0.325 V in its free state. This change further makes the utilization of the electron mediator by microorganisms difficult.

Furthermore, when a microbial fuel cell producing a current density of a practical power generation level of about 0.1 mA/cm² or more is constructed, the cathode side becomes alkaline as seen in a fuel cell and the potential of the cathode is lowered. It is known that even by using a silver catalyst to form the state of a flow of a small current of about 0.1 mA/cm², the cathode potential is lowered to about +0.1 V. From this fact, it is necessary that the potential of the anode is possibly the smallest value up to +0.1 V.

Further, since at least a part of the microorganisms belonging to the sulfur-reducing bacteria and the iron (III) oxide-reducing bacteria can directly transfer electrons to the electrode to some extent even in the environment where an electron mediator is absent, a technique of a microbial fuel cell without using any electron mediator is proposed (Japanese Patent No. 3022431). However, although this method has an advantage of retaining no electron mediator within the system, electrons cannot be efficiently transmitted from microorganisms to the electrode, and thus the current density cannot be increased. Consequently, when the method disclosed in this document is used in the power generation method utilizing an organic substance which is the target of this invention, there is a difficulty in obtaining a power generating rate for practical purposes.

### SUMMARY OF THE INVENTION

The problem of the present invention is to solve the above described points at issue of the conventional techniques to provide a method of efficiently obtaining electrical energy from a water-containing organic substance.

More specifically, the problem of the present invention resides in providing a method of using an electron mediator having an appropriate potential for transmitting electrons between anaerobic microorganisms and an anode to form an effective potential cascade between a microbial final reducing enzyme, an electron mediator and the anode causing a sufficiently low anode potential to generate electrical energy from the water-containing organic substances.

As the means to solve the above described problem, the present invention provides a method of generating electric power comprising:

forming a closed circuit by electrically connecting an anode formed by immobilizing an electron mediator having a standard electrode potential (E₀′) at pH 7 in the range of −0.13 V to −0.28 V on an electrode and a cathode;

bringing said anode into contact with microorganisms capable of growing under anaerobic conditions and a solution or suspension containing organic substances to advance the oxidation reaction by the microorganisms using said organic substances as an electron donor;

advancing the reduction reaction using oxygen as an electron acceptor at said cathode isolated from said solution or suspension through an electrolyte membrane; and

accelerating the oxidation reaction in the biological system to generate power and an apparatus for carrying out such a method of generating electric power.

Thus, the immobilization of an electron mediator having a standard electrode potential (E₀′) at pH 7 in the range of −0.13 V to −0.28 V to the anode efficiently transmits electrons from microorganisms to the anode through the electron mediator to smoothly advance an electrochemical reaction such that the electrons smoothly flow from the anode to the cathode and are delivered to the oxygen in air. By advancement of this reaction, the water-containing organic substance undergoes oxidative decomposition to effectively take out electrical energy as the so-called microbial fuel cell made efficient.

### BRIEF DESCRIPTION OF THE DRAWINGS

Specific examples of the generating electric power apparatus utilizing a water-containing organic substance according to this invention will now be explained by referring to the Drawings in which:

FIG. 1 is a conceptual diagram showing a constitution example of the generating electric power apparatus of this invention.

FIG. 2 is a conceptual diagram showing a constitution example of the generating electric power apparatus of this invention.

FIG. 3 is a conceptual diagram showing one example of the structure of a cathode electrode which can be used in the generating electric power apparatus of this invention, and FIG. 3A is a vertical sectional view and FIG. 3B is a sectional view taken along line 3-3 in FIG. 3A.

FIG. 4 is a conceptual view showing another example of the structure of a cathode structure which can be used in the generating electric power apparatus of this invention.

FIG. 5 is a conceptual view showing the constitution of the generating electric power apparatus of this invention which was used in the examples.

### DETAILED DESCRIPTION OF THE PREFERRED EMBODIMENT

The present invention is characterized in that the electron mediator having a standard electrode potential (E₀′) at pH 7 in the range of −0.13 V to −0.28 V, preferably −0.15 V to −0.27 V, more preferably −0.18 V to −0.23 V is immobilized on to the anode.

The electron mediator which can be used in this invention is preferably a substance which has a standard electrode potential in the above described range, is stable in the environment in both the reduction type and the oxidation type, does not inhibit the respiration of microorganisms and can be easily reduced. Preferably the electron mediator which can be used in this invention is a substance selected from the group consisting of anthraquinone derivatives, naphthoquinone derivatives, azobenzene derivatives and isoalloxazine derivatives. More specifically, the substance selected from the group consisting of anthraquinone-2-carboxylic acid (hereinafter referred to as “AQC”), anthraquinone-2-sulfonic acid (hereinafter referred to as “AQS”), anthraquinone-2,6-disulfonic acid (hereinafter referred to as “AQ-2,6-DS”), anthraquinone-2,7-disulfonic acid (hereinafter referred to as “AQ-2,7-DS”), anthraquinone-1,5-disulfonic acid (hereinafter referred to as “AQ-1,5-DS”), lapachol (hereinafter referred to as “LpQ”), Metanil Yellow, Methyl Orange, flavin mononucleotide (hereinafter referred to as “FMN”) and their derivatives can be preferably used. The structures and their standard electrode potentials of the substances which can be preferably used as the electron mediators in this invention are shown below.

[Formula 2]

| | | |
|---|---|---|
| AQO | 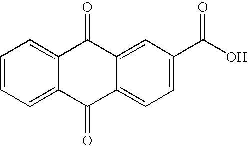 | −0.255 V |
| AQS | 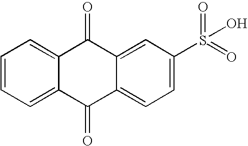 | −0.215 V |
| AQ-2,6-DS | 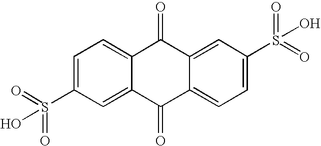 | −0.185 V |
| AQ-2,7-DS | 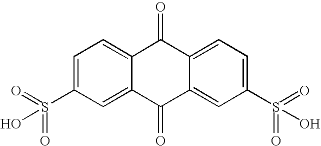 | −0.180 V |
| AQ-1,5-DS | 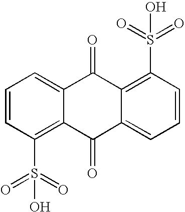 | −0.173 V |
| LpQ | 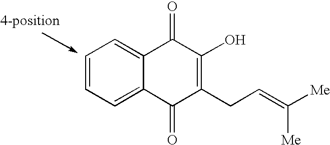 | −0.155 V |
| Metanil yellow | 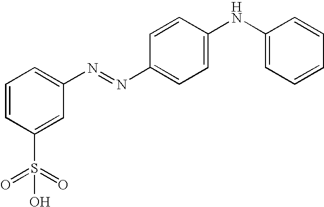 | −0.27 V |
| Metanil orange | 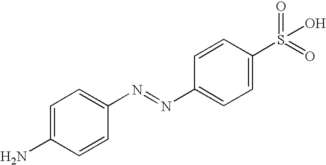 | −0.27 V |
| FMN | 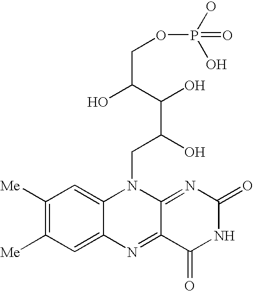 | −0.22 V |

It is preferred in this present invention that the method of immobilizing the electron mediator on to the anode neither inhibits oxidation and reduction nor largely varies the standard electrode potential of the electron mediator. Further, it is necessary that the electron mediator is bonded to the material of the electrode in an electrically conductive state. Furthermore, it is desirable that the bonding between the electron mediator and the material of the anode is stable in the aqueous environment and is not easily decomposed. The present inventors strenuously investigated and have found that as the immobilization method meeting these conditions, the chemically bonding method shown in the following Table 3 is appropriate.

TABLE 3
Method of Bonding Various Electrodes to Electron mediators

| Electrode | | | |
|---|---|---|---|
| Material | | | |
| or | Functional Group | Functional Group | |
| Coating | of | of | |
| Material | Electrode | Electron Mediator | Bonding Mode |
| Graphite | Carboxyl group | Amino group | Amide bonding or |
| | | | Imide bonding |
| | Amino group | Carboxyl group | Amide bonding |
| | | Sulfonic acid group | Sulfonamide bonding |
| | Hydroxyl group | Bromomethyl group | Ether bonding |
| | | Phosphoric acid group | Phosphate bonding |
| | | Phosphonic acid group | Phosphonate bonding |
| Gold | None | Thiol group (introduced to | Gold- or Platinum- |
| or platinum | | carboxyl group by ester | sulfur |
| | | bonding) | bonding |
| | | Thiol group (introduced | |
| | | to sulfonic acid group by | |
| | | ester bonding) | |
| | | Thiol group (introduced | |
| | | to hydroxyl group by | |
| | | ether bonding) | |
| | | Thiol group (introduced | |
| | | to amino group) | |
| | | Dithiol group (introduced | |
| | | to phosphoric acid group | |
| | | by diester bonding) | |
| Metal | Silane coupler | | |
| oxides | modification | | |
| (TiO₂, | Amine-containing | Carboxyl group | Amide bonding |
| SnO₂ | silane coupler | Sulfonic acid group | Sulfonamide bonding |
| etc.) | Halogen-containing | Hydroxyl group | Ether bonding |
| | silane coupler | Amino group | C-N bonding |
| | Hydroxyl group- | Phosphoric acid group | Phosphate bonding |
| | containing silane | | |
| | coupler | | |

Accordingly, in this invention, in order to immobilize the electron mediator onto the electrode, an appropriate chemical modification and an appropriate bonding method can be suitably selected from the methods shown in Table 3 depending on the combination of the electrode material and the electron mediator used.

For example, in the case of using graphite as the electrode material and AQC (anthraquinone-2-carboxylic acid) as the electron mediator, a bonding method utilizing the carboxyl group of AQC can be preferably selected. Specifically, graphite is cleaved by the nitric acid oxidation or the high temperature air oxidation of graphite to form a carboxyl group at the terminal which is then reacted with thionyl chloride to form a carboxylic chloride. Then, the obtained carboxylic chloride is reacted with ammonia to form a carboxylic amide. Furthermore, the obtained carboxylic amide is rearranged by the Hofmann rearrangement to an amino group. The graphite thus treated is reacted with AQC in the presence of dicyclohexylcarbodiimide to form an amide bonding between the carboxyl group of AQC and the amino group of graphite, and thus AQC can be stably immobilized to the graphite.

Further, as the method of introducing a functional group into graphite, electrolytic oxidation can be used. For example, in the case of introducing an amino group into graphite, the carboxyl group is converted to a carboxylic chloride to introduce an amino group. In other words, an anodic potential is applied to graphite to cleave the surface benzene ring by electrolytic oxidation reaction to introduce a carboxyl group which is then converted to a carboxylic chloride, and thereafter the carboxylic chloride is reacted with a diamine to introduce an amino group.
[Formula 3]

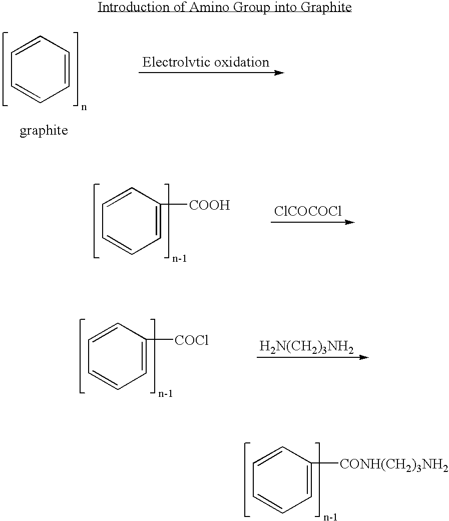

Specifically, a graphite plate is connected to the opposite electrode through a power source device and dipped in a 20% sulfuric acid solution and subjected to electrolytic oxidation using the graphite as an anode at a current density of the anode of 30 to 60 mA/cm² for 30 minutes to one hour. By this treatment, a carboxyl group and a hydroxyl group can be introduced on the surface of the graphite plate. The amount of the carboxyl group introduced can be estimated, for example, by measuring the amount of sodium hydrogencarbonate consumed. The carboxyl group introduced graphite plate is dipped in dichloromethane and added with oxyalyl chloride about 100 times the mole of the introduced carboxyl group and several drops of dimethylformamide and reacted at room temperature for about four to 12 hours by stirring to convert the above described carboxyl group to the carboxylic chloride. Thereafter, the graphite plate is washed with dichloromethane and transferred into a tetrahydrofuran solvent. The tetrahydrofuran solvent is added with 1,3-propanediamine in an amount of about 100 times the mole of the carboxylic chloride in the same manner as described above and reacted at room temperature for about 4 to 12 hours to introduce an amino group.

Alternatively, the use of the hydroxyl group introduced by the above described nitric acid oxidation, the high temperature air oxidation, the electrolyte oxidation or the like can form an ether bonding with an electron mediator having a bromomethyl group.

Similarly, in the case of using a graphite plate as the electrode material and immobilizing a substance having a sulfonic acid group such as ASQ, AQ-2,6-DS, AQ-2,7-DS, AQ-1,5-DS, Metanil Yellow and Methyl Orange as the electron mediator, an amino group is introduced into the graphite plate and thereafter reacted with the electron mediator in the presence of dicyclohexylcarbodiimide to form a sulfonamide bonding, and thus the electron mediator can be immobilized to the graphite plate.

Alternatively, in the case of immobilizing the above described sulfonic acid group-containing substances onto a graphite plate, the sulfonic acid group is previously converted to a sulfonyl chloride and thereafter the sulfonyl chloride is reacted with the amino group introduced onto the graphite plate by the above described electrolytic oxidation to form a sulfonamide bonding, and thus the electron mediator can be immobilized to the graphite plate.
[Formula 4]

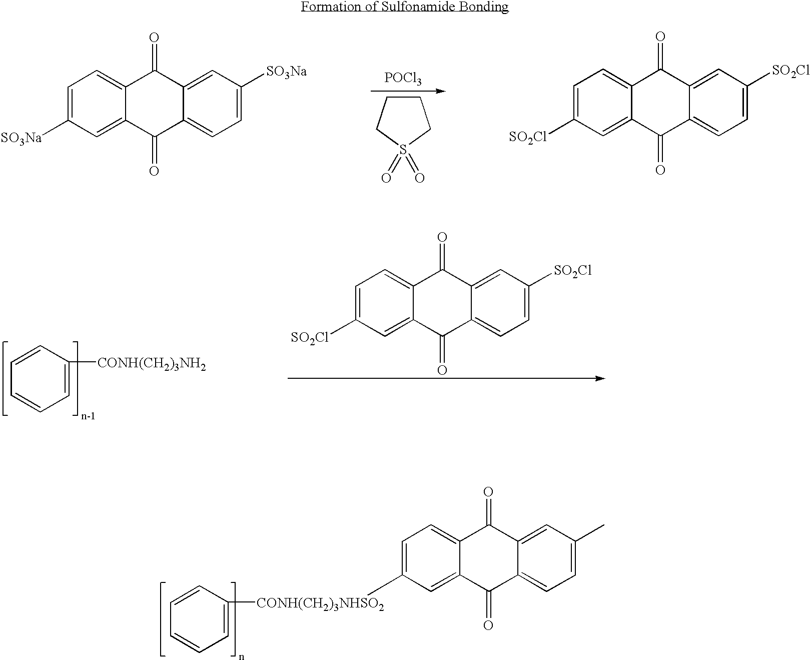

Specifically, the electron mediator is reacted with phosphorus oxychloride in an acetonitrile solvent containing sulfolane in an amount corresponding to ½ mole of the electron mediator and the phosphorus oxychloride in an amount corresponding to four times the mole of the electron mediator at 70° C. for one hour, and then it was filtered, washed with ice-water and then dried to convert the sulfonic acid group of the electron mediator into a sulfonyl chloride. The obtained electron mediator is brought into contact with the above described amino group-introduced graphite in a tetrahydrofuran solvent and reacted in the presence of triethylamine in an amount corresponding to five times the mole of the sulfonyl chloride at room temperature for about 12 hours to form a sulfonamide bonding between the graphite and the electron mediator.

Further, in the case of using graphite as the electrode material and LpQ as the electron mediator, it is preferred that the terminal carboxylic acid-introduced into the graphite is reduced to introduce a hydroxyl group, and the 4-position carbon of the LpQ is bromomethylated and thereafter an ether-bonding is formed to the hydroxyl group-introduced graphite to immobilize the LpQ to the graphite.

Further, in the case of using graphite as the electrode material and FMN as the electron mediator, a hydroxyl group is introduced into the graphite and reacted under alkaline conditions with the FMN whose any one of the two methyl groups has been bromated with the use of an equivalent amount of N-bromosuccinimide to immobilize the FMN to the graphite by an ether bonding.

As the material of the electrode constituting the anode on to which the electron mediator is immobilized in the present invention, a material capable of immobilizing the above described electron mediators is preferred, and as shown in Table 3, graphite, gold, platinum, metal oxides such as TiO₂ and SnO₂ or a metal covered with a metal oxide can be preferably used.

In the present invention, the reaction on the anode side finally delivers electrons derived from the organic substance to the anode through the electron transmission system within microorganisms and the electron mediator immobilized on to the anode mainly by the respiration of the microorganisms. Accordingly, it is desirable that the electron mediator-immobilized anode has the largest possible area and is efficiently brought into contact with microorganisms. In order to increase the reaction surface area of the anode to enhance reactivity, it is preferred that the electrode material is rendered into a powder and integrated with a resin binder to make the electrode porous. In the case of making the electrode porous, immobilization of the electron mediator may be performed by the above described bonding method of immobilizing the electron mediator to the porous electrode or by previously immobilizing a porous electrode material on to the electrode by the above described method and then integrating a resin binder or an electrically conductive paste with the electrode material. The latter case increases the supporting area of the electron mediator to enhance reactivity and is therefore preferred.

In the case of the apparatus for continuously treating the water-containing organic substance over a long period, anaerobic microorganisms continuously proliferate in the water-containing organic substance and on the surface of the anode and accordingly, the use of an anode electrode having too fine a three-dimensional network structure or a fine tubular or narrow spaced laminate structure is thought to decompose the water-containing organic substance and to lower the efficiency of power generation by clogging of the flow passage, the formation of a sided flow and a dead zone by microbial bodies and the like. On account of this, it is desirable that the form of the anode has a primary structure having a wire net, porous, irregular or pleated surface and a secondary structure having a three-dimensional network, tubular or laminate space (a flow passage for inflow of the water-containing organic substance) and simultaneously the above described flow passage has an opening of several millimeters to several centimeters in accordance with the flow ability of the water-containing organic substance which comes to the target for treatment. Further, depending on its application, it is desirable that the above described flow passage is washed with water or air with time to remove excess microorganisms and outer cellular secretions. In this instance, when the gas used in air washing contains oxygen, there is a possibility of adversely affecting the anaerobic microorganisms in the reaction vessel of the anode compartment (microbial reaction chamber) which will be described below, and accordingly it is desirable to utilize an inert gas or an anaerobic gas generated in the reaction vessel.

In this invention, the electron mediator-immobilized anode is brought into contact with microorganisms capable of growing under anaerobic conditions and a solution or suspension containing an organic substance to advance the oxidation reaction by microorganisms using the organic substance as an electron donor. This reaction on the anode side, that is, the oxidation reaction by microorganisms using the organic substance as an electron donor is biochemically catalyzed by anaerobic microorganisms (facultative anaerobic microorganisms or strict anaerobic microorganisms) in the water-containing organic substance, and electrons derived from the organic substance are finally delivered to the anode through the electron transmission system within microbial bodies mainly by the anaerobic respiration of the microorganisms. Thus, in order to efficiently perform the power generation reaction of this invention, it is desirable to utilize microorganisms which do not terminate the electron transmission system within the cell membranes of the microorganisms but easily pass electrons from the outer cell membranes (outside the cell membranes) of the microorganisms to the anode to catalyze the transmission of electrons to the anode. As such microorganisms that catalyze this electron transmission to the anode, sulfur (S)(0)-reducing bacteria, iron (Fe) (III) oxide-reducing bacteria, manganese dioxide (MnO₂)-reducing bacteria, dechlorination bacteria and the like are preferably used. As such bacteria, Desulfuromonas sp., Desulfitobacterium sp., Clostridium thiosulfatireducens, Acidithiobacillus sp., Geothrix sp., Geobacter sp., Shewanella putrefaciens. [all can be purchased from ATTC or National institute of Technology and Evaluation (NITE)] and the like are particularly preferably used. Particularly, sulfur-reducing bacteria have a standard electrode potential of sulfur of the final electron acceptor of as low as −0.28 V and can transmit electrons to an electron mediator having a lower potential of the iron (III) oxide-reducing bacteria, and thus are energetically advantageous. As the microorganisms having such a sulfur-reducing activity, for example, Desulfuromonas sp., Desulftobacterium sp., Clostridium thiosulfatireducens, Acidithiobacillus sp. and the like are preferably used.

These microorganisms are mostly not the major bacteria in the water-containing organic substance, and thus in carrying out the method of this invention, it is preferred that these bacteria are first planted on the anode side to form a state of these microorganisms attached to the surface of the electrode. In order for these microorganisms to predominantly grow within a microbial reaction chamber, the area of the site where the respiration reaction (electrode respiration) to deliver electrons to the electrode is energetically more advantageous than acid fermentation and methane generation should be enlarged and specifically, the anode surface in the microbial reaction chamber is preferably enlarged as much as possible. Further, it is desirable that after attachment of microorganisms to the anode surface, a medium suitable for the proliferation of these microorganisms is supplied, and it is more desirable that by maintaining the potential of the anode high, the proliferation of these microorganisms on the anode surface is promoted. As the method of culturing microorganisms (or microorganisms consortium) in the pre-culture or in the microbial reaction chamber, various types of media including a slurry sulfur and media using an electron acceptor such as iron (III) oxide and manganese dioxide are reported, and for example, Ancylbacter/Spirosoma medium, Desulfuromonas medium, Fe (III) Lactate Nutrient medium and the like described in the Handbook of Microbial Media (Atlas et., 1997, CRC Press) are preferably used.

In this invention, the anode is brought into contact with microorganisms capable of growing under anaerobic conditions and a solution or suspension containing an organic substance to advance the oxidation reaction by the microorganisms using the organic substance as the electron donor. It is desirable that the form of the organic substance is a solution or suspension or the voids of the solid content of the organic substance is saturated with water so as to not supply molecular oxygen around the anode where the microorganisms can proliferate under anaerobic conditions. The above described oxidation reaction of the organic substance around the anode is mainly catalyzed by the respiration reaction of the microorganisms, and accordingly it is desirable that the organic substance to be introduced around the anode has a small particle diameter of the solid content, is well dissolved or dispersed in water and has a lower molecular weight, and further is easily decomposable by the microorganisms. When these conditions are not met depending on the type of the organic substance used, the organic substance can be physically, chemically or biologically pretreated to enhance its microbial decomposability. Such methods are thought to include crushing by a pulverizer, a thermal decomposition, an ultrasonic treatment, an ozone treatment, a hypochlorite treatment, a hydrogen peroxide treatment, a sulfuric acid treatment, and a microbial treatment such as a hydrolysis, an acid formation and a degradation of high molecular weight substances. The energy required for these pre-treatments can be selected based on optimum pretreatment conditions in consideration of the balance with improvement of the power generation energy in the main reaction vessel by the pretreatment.

In this invention, the electron mediator immobilized electrode is used as an anode and the other electrode is used as a cathode and the anode and the cathode are electrically connected to form a closed circuit. In this invention, the reduction reaction using oxygen as an electron acceptor proceeds on the cathode side. It is preferred that at least part of the cathode is constituted of an electrically conductive porous material, an electrically conductive network or fibrous material which have voids in the structure and the contact interface of water/air, that is, the site of allowing air (oxygen) to adjoin water is preferably constructed in the voids to enhance the efficiency of bringing the oxygen in the air into contact with the water of the water surface, and thus the reduction reaction (electrode reaction) of the oxygen in the air can be accelerated. For example, by using a cathode obtained by integrating an electrically conductive porous material having fine pores with electrically conductive particles (such as carbon, an inert metal and a metal oxide) by a resin binder, water is effectively sucked by the capillary phenomenon, the hydrophilized surface or the like to form the contact interface of water/air within fine pores, and thus the oxygen in the air is efficiently brought into contact with water to accelerate the reduction reaction of the oxygen.

Furthermore, it is preferred that the cathode supports a catalyst comprising an alloy or a compound containing at least one kind selected from platinum family metals, silver and transition metal elements, and the reduction reaction of the oxygen in the air (electrode reaction) can be accelerated. The platinum family elements indicate platinum (Pt), ruthenium (Re), rhodium (Rh), palladium (Pd), osmium (Os) and iridium (Ir) and any of them is effective as an electrode catalyst. Catalysts supporting a silver powder doped with nickel (Ni), bismuth (Bi) or titanium oxide, supporting silver supported on furnace black or colloidal graphite and using iron (Fe), cobalt (Co), phthalocyanine, hemin, perovskite, Mn₄N, a metal porphyrin, MnO₂, a vanadate or Y₂O₃—ZrO₂ composite oxide are preferably used as electrode catalysts.

In this invention, the anode and the cathode are electrically connected to form a closed circuit. In order to take out the reducibility of the organic substance as electrical energy at one of the electrodes, the organic substrate and oxygen in the air have to be isolated so as for the organic substance to not consume the reducibility by bringing the organic substance in contact with an oxidizing agent (reducible substance) of the oxygen in air, in other words, so as to not bring the organic substance in contact with the oxygen in the air. In order to simultaneously meet these conditions, the cathode is desirably isolated from the microorganisms capable of growing under anaerobic conditions and the solution or suspension containing the organic substance by an electrolyte membrane, for example, a solid high-molecular electrolyte membrane. By taking such a structure, the cathode can be easily brought into contact with the oxygen in the air, and can receive hydrogen ions or discharge hydroxide ions through the water present in the above described electrolyte membrane. Desirably, the electrolyte membrane allows the oxygen in the air to permeate as little as possible to prevent the deterioration of the reducibility of the anode side, that is, the organic substance due to the permeation of oxygen into the organic substance.

As such an electrolyte membrane, a sulfonic acid group-containing fluororesin ion-exchange membrane having hydrophilicity and high cation exchangeability (a cation exchange resin), a quaternary ammonium salt-containing hydroxide ion-exchange membrane (an anion-exchange membrane) and the like are preferably used. Further, a fluororesin ion-exchange membrane obtained by fluorinating the main chain alone as a more inexpensive electrolyte membrane and an aromatic hydrocarbon membrane can also be utilized. As such, ion-exchange membranes, commercially available products such as NEPTON CR61AZL-389 manufactured by IONICS, NEOSEPTA CM-1 and CMB manufactured by Tokuyama, Selemion CSV manufactured by Asahi Glass, NEPTON AR103PZL, manufactured by IONICS, NEOSEPTA AHA manufactured by Tokuyama and Selemion ASV manufactured by Asahi Glass can be preferably used. The cation-exchange membrane can be used for supplying hydrogen ions and water necessary for the reduction of oxygen at the cathode from the anode to the cathode, and the anion-exchange membrane can be used for supplying hydroxide ions generated by the reaction between water and oxygen from the cathode to the anode.

Further, this invention provides a generating electric power apparatus having an anode compartment and a cathode compartment partitioned by an electrolyte membrane, wherein the anode compartment has an anode on to which an electron mediator having a standard electrode potential (E₀′) of −0.13 V to −0.28 V is immobilized, microorganisms capable of growing under anaerobic conditions and a feed mechanism and a discharge mechanism for a solution or suspension containing an organic substance; and the cathode compartment has a cathode and a feed mechanism and a discharge mechanism for oxygen or air. In the generating electric power apparatus, an object for utilizing power such as lighting equipment and a sensor can be electrically connected between the anode and the cathode to take out and utilize the necessary power.

In this generating electric power apparatus, the anode compartment is a microbial reaction chamber for advancing the oxidation reaction by the microorganisms to finally deliver the electrons derived from the organic substance to the anode through the electron transmission system within the microbial bodies by the respiration reaction of the microorganisms capable of growing under anaerobic conditions, and the cathode compartment is an air reaction chamber for advancing the reduction reaction using oxygen as an electron acceptor. In the generating electric power apparatus, since the anode on to which an electron mediator having a potential suitable for transmitting electrons between the anaerobic microorganisms and the anode is immobilized is provided, an effective potential cascade is formed in the microbial final reducing enzyme-electron mediator-anode. The anode, the electron mediator immobilized on to the anode, the cathode and the electrolyte membrane for partitioning the anode compartment from the cathode compartment in the generating electric power apparatus can preferably use the bioelectogenis method of this invention as explained in detail.

When the partition membrane for partitioning the anode compartment (microbial reaction chamber) from the cathode compartment (air reaction chamber) is a cation-exchange member, the reduction reaction utilizing hydrogen ions at the cathode sometimes restricts the entire reaction rate which participates in the power generation of this invention depending on the condition of the hydrogen concentration. More specifically, the oxidation reaction at the anode is by microorganisms, and accordingly extremely acidic conditions are possibly unsuitable due to the inhibition of the activity of the microorganisms. Further, when the concentration of hydrogen ions is low, for example, under the conditions of pH 5 or more, hydrogen ions are generated on the anode side and the hydrogen ions are diffused in the cation-exchange membrane and supplied to the cathode side. At this time, the concentration of hydrogen ions on the cathode side is estimated at about 10⁻⁵ mol/L or less. Thus, when the concentration of hydrogen ions comes to low concentration conditions, the rate of the reduction reaction of oxygen on the cathode side is lowered and it is expected that the hydrogen ions on the anode side do not efficiently migrate to the cathode side. In other words, in this instance, the electric resistance (inner resistance) as a support electrolyte forming a cell is possibly increased. On the other hand, the advantage of this reaction system resides in continuous and sufficient supply of water and hydrogen ions from the anode side to the cathode side to hardly cause the problem of the so-called cross flow of consumption of the reducibility on the anode side due to the permeation of oxygen on the cathode side to the anode side through the membrane.

When a cation-exchange membrane is used as the electrolyte membrane, the oxygen in the air is consumed in the reaction on the cathode side to generate water. On account of this, it is necessary to continuously replenish oxygen by ventilation and prevent excess wetting of the cathode by removing water. However, the amount of water retained on the cathode side varies depending on the humidity and the flow rate of the air supplied at this time, and thus it is desirable to suitably control the drying-moistening of the cathode. As the ventilation method of supplying and discharging air, a method of natural convection replacement in an opened system, a method of providing an air chamber by enveloping the periphery of the cathode with an outer shell and forcibly ventilating the inside of the air chamber by a blower and a method of providing an air chamber, warming up the inside of the air chamber by the heat generated by the oxidation-reduction reaction, causing convection to allow air and steam to ascend to perform ventilation may be thought, and the ventilation method is preferably employed in accordance with the conditions such as the installing site and the size of the apparatus of this invention.

On the other hand, when an anion-exchange membrane is used as the electrolyte membrane, in other words, when the reaction system of generating hydroxide ions from water and oxygen in the cathode chamber, the cathode compartment has a very small amount of water retained compared to the anode compartment and thus, if the same equivalent amount of hydroxide ions as the amount of hydrogen ions generated at the anode is generated at the cathode, the pH on the cathode side can be made extremely high, that is, the concentration of hydroxide ions can be greatly increased. The hydroxide ions having a concentration efficiently permeate through the anion-exchange membrane and thus can lower the electric resistance (inner resistance) of the support electrolyte. On the other hand, this reaction system has a problem of possibly causing the above described cross flow, in that water supply to the cathode side becomes difficult due to the constant migration of ions from the cathode side to the anode side and the oxygen on the cathode side permeates through the membrane to the anode side to consume the reducibility of the anode side.

Further, when an anion-exchange membrane is used as the electrolyte membrane, the oxygen and the water on the cathode surface are consumed in the reaction of the cathode side to generate hydroxide ions. For this account, it is sometimes necessary to constantly replenish oxygen by ventilation and to replenish water to prevent the cathode from drying. Particularly, when the ventilation air is dry and when the water supply rate by permeation from the anode side is lower than the water consumption rate due to the evaporation and the reduction reaction at the cathode, it is desirable to moisten the ventilation air or to supply water to the cathode by addition of a stream.

As described above, the cation-exchange membrane and the anion-exchange membrane utilized as electrolyte membranes have an effect of greatly changing the reaction system involved in the power generation reaction and have respective advantages and problems to be improved, and thus their employment should be judged in accordance with the structure and the application of the apparatus and the properties of the water-containing substance.

In order to increase the migration efficiency of hydrogen ions or hydroxide ions, it is desirable that the distance between the cathode and the above described electrolyte may be as short as possible and both are joined if possible from the standpoint of the structure of the apparatus. Particularly, when a part of the electrolyte network-wise penetrates into the voids inside the porous structure of the cathode electrode and is bonded, the area of the water/air contact interface formed of the air in the porous structure and the water present in the electrolyte is remarkably increased, and thus the reaction efficiency of reducing the oxygen in the air can be increased to enhance the power generation performance.

Similarly, also in order to ease the migration of hydrogen ions or hydroxide ions and reduce the electric resistance of the electrolyte solution system, the distance between the anode and the above described electrolyte is desirably made as short as possible, and the anode and the electrolyte membrane are preferably arranged in contact. In this case, however, in order to allow the organic substance in contact with the electrolyte for the electrolyte membrane to absorb the water in the organic substance, it is necessary for the anode to have a water permeable form, for example, to be constituted of a porous material and a network material or a form having a water passage hole, for example, a grid-like or comb-like form. When the arrangement of the anode in contact with the electrolyte membrane is difficult from the standpoint of the structure of the apparatus, for example, a stirring or circulating water flow is desirably caused to form a water flow circulating between the anode and the electrolyte membrane, and thus the migration of hydrogen ions or hydroxide ions is desirably made easy.

Further, the form of the reaction vessel relating to this invention should be considered not to form a dead zone where the water-containing organic substance and bacterial bodies of proliferated microorganisms stay. One technique for this purpose is to cause a stirring or circulating of a water flow to increase the contact efficiency between the organic substance and the anode electrode. Further, in the case of making the reaction vessel a sealed structure, any gas withdrawal mechanism is desirably provided to prevent the effective volume from decreasing due to the accumulation of an anaerobic gas in the vessel. This anaerobic gas can be naturally utilized in the method of washing the flow passage with air as described above.

### BEST MODE FOR CARRYING OUT THE INVENTION

The following description is to explain several specific modes which embody the technical thought of this invention.

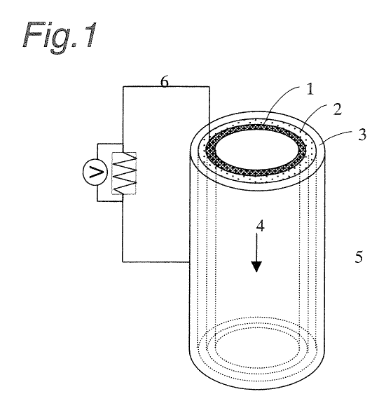

FIG. 1 is a specific example of a power generation unit relating to one embodiment of this invention. In order to efficiently deliver electrons of an organic substance (hereinafter referred to as substrate) to the anode, it is needed that the surface area is made large; the anode is efficiently brought into contact with the substrate to form no dead zone where the substrate does not move; ions efficiently migrate from the anode to the cathode; and simultaneously the anode is electrically insulated from the cathode. For that purpose, the anode is made tubular, for example, cylindrical to allow the substrate to flow therethrough and the unit is preferably constituted by holding an electrolyte membrane in between the anode and the cathode in three contacting layers. One specific example of the generating electric power apparatus of this invention constituted by a membrane/electrode structure as shown in FIG. 1 is constituted by forming a three-layered cylinder of an anode 1 on to which an electron mediator is immobilized, an electrolyte membrane 2 and a porous cathode 3. By allowing the substrate to flow in the inner space 4 and allowing air to be present around the circumference 5 of the cylinder, a potential difference is produced between the anode 1 and the cathode 3. In this state, the anode 1 and the cathode 3 are electrically connected by a conductor wire 6 to allow a potential difference of current to flow, and on the other hand, by migration of ions between the anode 1 and cathode 3 through the electrolyte membrane 2, a closed circuit is formed.

The inner diameter of the cylinder can be set at several millimeters to several centimeters, if necessary or desired, several tens of centimeters in accordance with the flow ability of the substrate. The generating electric power apparatus unit shown in FIG. 1 can be held by a support layer of a suitable material or a casing to increase its physical strength. Further, in this instance, the cylinder may be further enveloped in an outer shell to form an air chamber between the outer shell and the cylinder as a means to feed and discharge air to and from the air chamber. Further, in arranging the electrolyte membrane in contact with the anode as shown in FIG. 1, it is necessary that the substrate solution is passed through the anode and brought into contact with the electrolyte membrane to absorb the water in the solution in the electrolyte membrane as explained above. For that purpose, the anode is preferably in a water permeable form, for example, formed of a network material or a porous material or in a lattice form.

In the generating electric power apparatus of a three-layered cylinder of this invention shown in FIG. 1, power generation can be operated by arranging the anode outside and the cathode inside depending on the application, arranging a means to allow air to flow in the space inside the cathode and installing the generating electric power apparatus in the substrate solution. In this instance, the cylinder may be formed, for example, in a U-shape and both ends are protruded from the liquid surface of the substrate solution so as to allow air to flow in the space inside the cylinder. Thus, in the case of the constitution having the cathode as an inner cylinder, there is advantageously no problem of causing clogging even when the inner diameter of the inner cylinder of the cathode is made to about several millimeters or less. Furthermore, when the three-layered cylinder has an inner cylinder 1 of a porous cathode, numeral 2 of an electrolyte membrane and an outer cylinder 3 of an anode, the surface area of the outer anode 2 can be advantageously enlarged compared to the cathode 1, and in order to further increase the area of the anode, it is also possible to allow the surface of the anode to have irregularities and folds. On the other hand, the inner diameter of the cathode side relates to reaction efficiency, and may have a diameter only for easy flowing of air and there is hardly a danger of clogging, and accordingly it is possible to reduce the inner diameter to about several millimeters or less. In this case, the generating electric power apparatus can be constituted by further enveloping the cylinder in an outer shell to form a reaction chamber of microorganisms in which the substrate flows in the outer space of the cylinder and arranging a means to feed and discharge the substrate to and from the microbial reaction chambers.

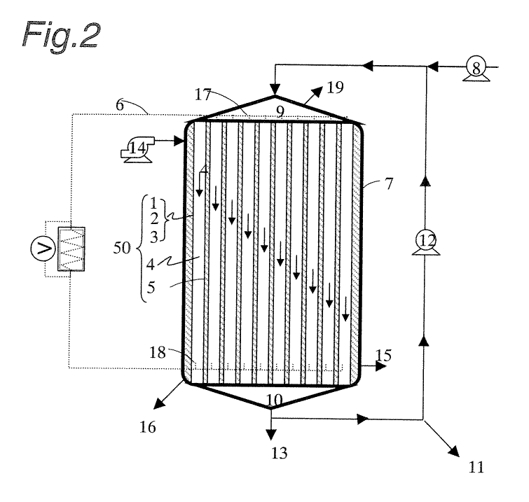

FIG. 2 shows a constitution example of the generating electric power apparatus of this invention in which a plurality of the three-layered cylinders as explained above are arranged. In the generating electric power apparatus shown in FIG. 2, a plurality of the three-layered cylinders (power generation units) 50 constituted of the inner cylinder 1 of the anode, the electrolyte membrane 2 and the outer cylinder 3 of the cathode as shown in FIG. 1 are arranged in an air chamber 7 formed of an outer shell. The substrate is introduced into the insides 4 of a plurality of the power generation units 50 arranged through an inflow part 9 by an inflow pump 8 in order that it can be distributed. Here, the substrate undergoes oxidation decomposition that flows out of the reactor vessel through an effluent part 10, and thereafter is discharged out of the system as a treated substrate 11. Part of the substrate is again returned to the inflow part 9 by a circulating pump 12. By this circulating flow, the contact of the anode 1 with the substrate is accelerated. The cell bodies of the microorganisms and the sludge accumulated in the reaction vessel are discharged with time by opening an excess sludge discharge outlet 13. Further, by introducing water, an inert gas and an anaerobic gas from the excess sludge discharge outlet 13 into the reaction vessel, the reactor vessel can be back-washed and air-washed. When an anaerobic gas is generated within the reaction vessel, it can be discharged from an air outlet 19. This anaerobic gas may be stored and used in air washing as described above.

On the other hand, in order to feed air to the cathode 3, the air chamber 7 can be ventilated with the use of a blower 14. However, when forced ventilation is not needed depending on the application, the generating electric power apparatus may be constituted by dismantling the air chamber 7 to expose the cathode 3 of the external cylinder of each of the power generation units 50 to the air. The ventilated air flows in the space 5 among the power generation units 50 within the air chamber 7 and is brought into contact with the cathodes 3, and thereafter discharged from an air outlet 15. Further, the water formed by the reduction reaction at the cathodes 3 is discharged from the air outlet 15 as steam or is discharged as condensed water from a condensed water drain 16.

A conductor wire 6 is electrically connected to the inner cylinders 1 of the plurality of the power generation units 50 by joints 17 with the anodes and the outer cylinders 3 of the plurality of the power generation units 50 by joints 18 with the cathodes. In this instance, it is necessary to electrically insulate the conductor wire 6 from the surrounding environment to cause no short circuit and no oxidation-reduction reaction on the surface of the conductor surface.

Also with the apparatus as shown in FIG. 2, as explained above with the apparatus of FIG. 1, each power generation unit 50 is constituted of an inner cylinder as the cathode and an outer cylinder as the anode, and air can be supplied to the inner space of each cylinder 50 to bring the anode outside the cylinder of the power generation unit 50 into contact with the substrate.

With the cathode, the problem is how efficiently the reduction reaction of oxygen is advanced on the electrode. For that purpose, it is preferred that by forming at least part of the cathode of an electrically conductive porous material or an electrically conductive network or fibrous material and bringing the air into the voids of this cathode in contact with water in the state of forming a contact interface between air and water, the efficiency of bringing the oxygen in the air into contact with water on the water surface is increased.

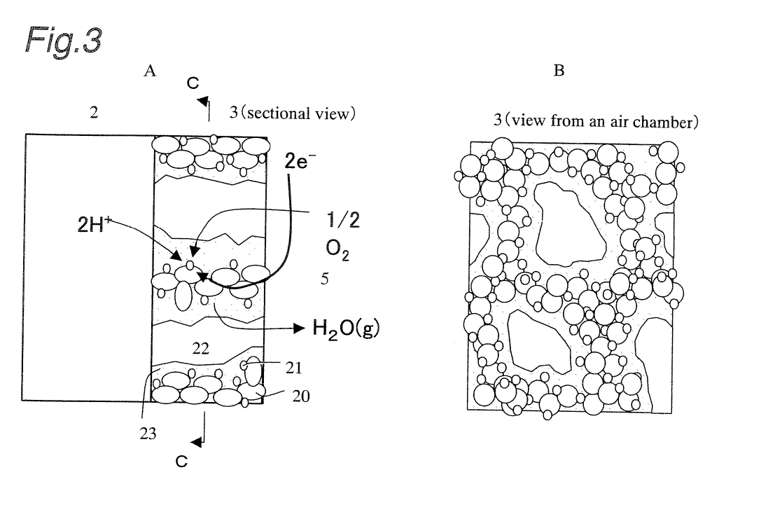

FIG. 3 shows a sectional view of one example of the cathode structure which can be employed in the apparatus of this invention and FIG. 3 A shows a section of the structure of an electrolyte membrane 2 and a cathode 3 and FIG. 3B is a sectional view taken along line 3-3 in FIG. 3A. Further, FIG. 3 shows a reaction system in which the electrolyte membrane 2 is a cation-exchange membrane. The cathode shown in FIG. 3 has a structure of supporting catalyst 21 comprising an alloy or compound preferably containing at least one kind selected from platinum family elements, silver and transition metal elements on a porous matrix 20 (FIG. 3 A) and shows a network structure viewed from the air chamber side 5 (FIG. 3B). By employing this structure, the cathode is brought into contact with the oxygen in the air while sucking out water via the water surface or the electrolyte membrane by capillary phenomenon or the like and by having an air network 22 and an aqueous solution network 23 in the microstructure of the electrode, the area of the air/water contact interface can be increased to enhance the contact efficiency of the oxygen in the air with water of the water surface. By the reaction of oxygen with a hydrogen ion on the catalyst 21, the reduction reaction of the oxygen in the air can be accelerated.

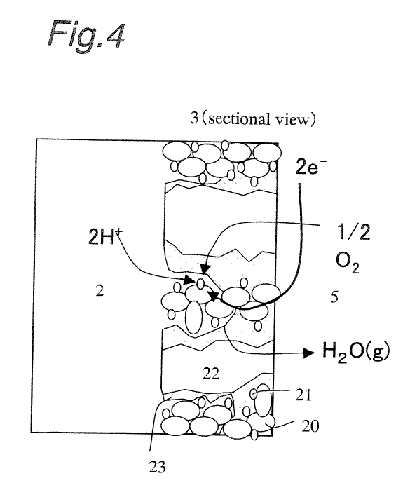

FIG. 4 shows another example of a cathode structure which can be employed in the apparatus of this invention. FIG. 4 also shows a reaction system in which the electrolyte membrane 2 is a cation-exchange membrane. The cathode shown in FIG. 4 is obtained by coating a solution comprising the same substance as the substance constituting the electrolyte membrane 2 on the side of the joint surface with the electrolyte membrane 2 of a porous matrix 20 and drying the coating to allow part of the structure of the electrolyte membrane 2 to flood into the fine pores of the porous matrix 20. Employment of this constitution can improve the utility ratio of the ion exchange and the catalyst to accelerate the reduction reaction of the oxygen in air.

### EXAMPLES

This invention will now be specifically explained by examples but this invention is not limited by these examples.

### Example 1

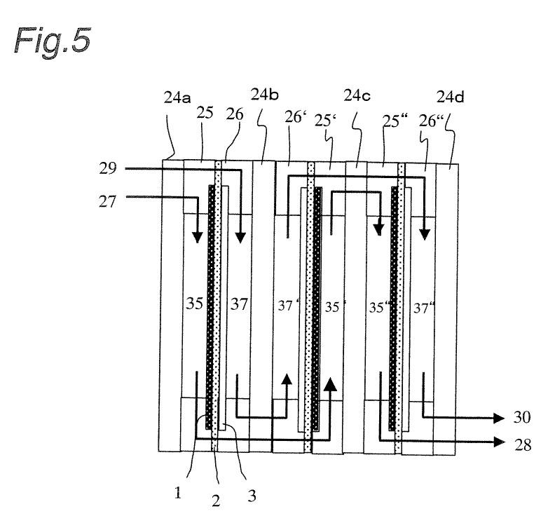

Power generation performance was compared when the generating electric power apparatus for an experiment shown in FIG. 5 was used and an electron mediator (AQ-2,6-DS) was immobilized on to an electrode (porous graphite) by a sulfonamide bonding (Example 1) and the electron mediator was merely added to the liquid phase (Control).

The generating electric power apparatus had a structure obtained by using a structure of laminating two sheets of cell frames (25, 26) having a side length of 100 mm and a thickness of 10 mm and two sheets of separators (24a, 24b) having the same size as a basic unit and laminating a plurality of the basic units. Specifically, a separator 24 was arranged adjacent to a cell frame 25, and a porous graphite on to which AQ-2,6-DS had been immobilized by a sulfonamide bonding at a density of 20 μmol/cm² was arranged as an anode 1. Then, an electrolyte membrane 2 made of a cation-exchange membrane (Nafion, DuPont) was arranged in contact with the anode 1, and a porous graphite supporting platinum as a cathode 3 was arranged in contact with the electrolyte membrane 2, and a cell frame 26 and a separator 24b were arranged. Thus, an anode compartment 35 and a cathode compartment 37 were formed. Then, a cell frame 26′ adjacent to the separator 24b, a cathode 3, an electrolyte membrane 2, an anode 1, a cell frame 25′ and a separator 24c were arranged to form an anode compartment 35′ and a cathode compartment 37′. Similarly, an anode compartment 35′″ and a cathode compartment 37″ were formed of a separator 24c, a cell frame 25″, an anode 1, an electrolyte membrane 2, a cathode 3, a cell frame 26″ and a separator 24d. The combination of the thus formed anode compartment 35 and cathode compartment 37 partitioned by separators 24a and 25b was taken as one unit. In each gasket (cell frame), flow passages (27 to 30) for allowing a substrate solution and air to flow were formed. Each anode 1 and each cathode 3 were electrically connected by a conductor wire (not shown in the Figure) to form a closed circuit. From an injection hole 27, 0.25 mol/L of a glucose aqueous solution was injected as a model of the water-containing substance and passed through each of the anode compartments 35, 35′, 35″ and thereafter discharged from a discharge outlet 28. Further, from an air inlet 29, air was ventilated and passed through each of the cathode compartments 37, 37′, 37″ and thereafter evacuated from a discharge outlet 30. The effective volume of the combined three units of this apparatus was 108 mL in both the anode compartment (microbial reaction chamber) and the cathode compartment (air reaction chamber), and the feed and discharge rates were adjusted so as for the residence time of both the glucose aqueous solution and the air to come to 5 minutes. The total surface area (apparent area) of the electrode was set at 108 cm² for both the anode and the cathode. In the anode compartments 35, 35′, 35″, 0.5 g of an anaerobic microorganism enrichment culture was added before the initiation of operation.

The anaerobic microorganism enrichment culture was prepared by the following method. Specifically, 0.1 g of Kuroboku soil was used as an inoculum and added to a medium obtained by injecting 100 mL of the Desulfuromonas medium (Table 4) described in Handbook of Microbial Media (Atlas et al., 1997, CRC Press) into a 130 mL-volume vial (container) and substituting the gas phase with a nitrogen gas, and the vial was sealed to perform shake culture at 28° C., and after two weeks, 5 mL of the bacterial liquor obtained was subcultivated in a newly prepared vial, and the operation of this procedure was repeated five times and the bacterial liquor obtained after 10 weeks was used as the anaerobic microorganism enrichment culture. Further, the soil of the planting seed source is not limited to Kuroboku soil and may be loam and silt.

TABLE 4
Composition of Desulfuromonas Medium (pH 7.2 ± 0.2)

| | | |
|---|---|---|
| Sulfur (colloidal) | 10 | g |
| Nutrient Liquid 1 (KH₂PO₄ 1 g, MgCl₂•6H₂O 0.4 g, | 1 | L |
| NH₄Cl 0.3 g, CaCl₂•H₂O 0.1 g, 2 mol/L-HCl 4.0 mL) in 1 L | | |
| Nutrient Liquid 3 (NaHCO₃ 10 g) in 100 mL | 20 | mL |
| Nutrient Liquid 4 (Na₂S•9H₂O 5 g) in 100 mL | 6 | mL |
| Nutrient Liquid 5 (pridoxamine dihydrochlorate 0.01 g, | 5 | mL |
| nicotinic acid 4 mg, p-aminobenzoic acid | | |
| 2 mg, thiamine 2 mg, cyanocobalamin 1 mg, | | |
| calcium pantothenate 1 mg, biotin 0.5 mg) in 200 mL | | |
| Nutrient Liquid 2 (EDTA disodium salt 5.2 g, | 1 | mL |
| CoCl₂•6H₂O 1.9 g, Fe₂Cl•4H₂O 1.5 g, | | |
| MnCl₂•4H₂O 1 g, ZnCl_{2 0.7 g, H}₃BO₃ 0.62 g, | | |
| Na₄MoO₄•2H₂O 0.36 g, NiCl₂•6H₂O 0.24 g, | | |
| CuCl₂•2H₂O 0.17 g) in 1 L | | |

For two days after the initiation of operating the generating electric power apparatus, a liquid was not allowed to flow to await the adhesion of the microorganisms to the inside of the anode compartment (microbial reaction chamber), and the Desulfuromonas medium shown in Table 4 was packed on the side of the anode compartment (microbial reaction compartment) to accelerate the dominance of sulfur-reducing bacteria. Thereafter, for eight days the residence time of the glucose aqueous solution was set at two days to perform the preliminary operation, and 10 days after the initiation of the preliminary operation, the normal operation with a residence time of 5 minutes was performed, and then the quantity of current and the voltage between the anode and the cathode were measured.

As a control, untreated porous graphite was used as the anode and instead of immobilizing AQ-2,6-DS on to the anode, a system of merely adding 20 μmol/L of AQ-2,6-DS to the liquid phase in the initial period was prepared, and in the same manner as in Example 1, 10 days after the initiation of the preliminary operation, the normal operation with a residence time of 5 minutes was performed and the quantity of current and the voltage between the anode and the cathode were measured. Further, the amount of AQ-2,6-DS added to the initial liquid phase in the control was about 10 times the amount of AQ-2,6-DS immobilized on to the anode.

In the above described Example and Comparative Example including the period of the preliminary experiment, the cathode and the anode were in a connected state at all times.

The experimental results are shown in Table 5. It would be understood that there was no great difference in the generated potential (voltage) but the generated current with the anode in which AQ-2,6-DS was immobilized on to porous graphite was about 180 times higher than the generated current when AQ-2,6-DS was added to the liquid phase. In each system, the quantity of the generated current and the voltage were almost stabilized in the continuous operation for further one week.

TABLE 5
Results of Power Generation Test

| | Generated | | Average |
|---|---|---|---|
| | Current | Voltage | Output |
| Experimental System | (mA) | (mV) | (mW) |
| Electron mediator | 3.07 × 10² | 330 | 101 |
| immobilized onto | | | |
| electrode (Example 1) | | | |
| Electron mediator | 1.7 | 270 | 0.46 |
| added to liquid phase | | | |
| (Control) | | | |

### Example 2

The power generation performance was compared when the generating electric power apparatus for experiment shown in FIG. 5 was used and the electron mediator (AQ-2,6-DS) was immobilized on to an electrode (porous graphite) by a sulfonamide bonding (Example 2) and Neutral Red was immobilized on to an electrode (Control).

The experimental conditions other than the constitution of the power generation unit and the electrode were the same as in Example 1. The method of immobilizing Neutral Red followed the method described in Park et al., 2000, Biotechnology Letters 22: 1301-1304. Specifically, graphite was connected to the other electrode through a power source apparatus, dipped in a 20% sulfuric acid solution and subjected to electrolytic oxidation using the graphite as an anode at a current density of the electrode of 40 mA/cm² for one hour. The carboxyl group-introduced graphite plate thus obtained was dipped in a carbodiimide solution having a concentration of 2 g/L and left to stand in this dipped state for one hour. Then, Neutral Red was added in an amount of 20 μmol/L and reacted at room temperature for 12 hours to immobilize neutral Red on to the graphite.

The experimental results are shown in Table 6. It would be understood that there was no great difference in the generated potential (voltage) but the quantity of the generated current with the anode of the porous graphite immobilized with AQ-2,6-DS by a sulfonamide bonding was about 58 times higher than the quantity of the generated current with the anode immobilized with neutral Red. In both systems, the quantity of the generated current was almost stabilized during continuous operation for further one week

TABLE 6
Results of Power Generation Test

| | Generated | | Average |
|---|---|---|---|
| | Current | Voltage | Output |
| Experimental System | (mA) | (mV) | (mW) |
| AQ-2, 6-DS immobilized | 2.98 × 10² | 320 | 95.36 |
| onto electrode (Example 2) | | | |
| Neutral Red immobilized | 5.1 | 337 | 1.719 |
| onto electrode (Control) | | | |

### Example 3

The power generation performance was compared when the generating electric power apparatus for experiment shown in FIG. 5 was used and the electron mediator (AQ-2,6-DS) was immobilized on to an electrode (porous graphite) by a sulfonamide bonding (Example 3) and AQ-2,6-DS was mixed with a photo-cross-linkable resin and a graphite powder, and the resulting mixture was coated on the electrode (porous graphite) and thereafter cured and immobilized by irradiation with ultraviolet rays from a mercury lamp on to the electrode (Control). In both cases the amount of AQ-2,6-DS immobilized was set at an electrode density of 20 μmol/L.

The experimental conditions other than the constitution of the power generation unit and the electrode were the same as in Example 1. The method of immobilizing with a photo-cross-linkable resin followed the method described in Japanese Patent Public Disclosure (KOKAI) No. S57-69667. Specifically, 3 g of epoxy acrylate, 0.92 g of AQ-2,6-DS chloride and 1 g of a graphite powder were dissolved/dispersed in 10 mL of ethyl acetate and thereafter the obtained solution/dispersion was uniformly sprayed on to three the above described porous graphite plates. The resulting plates were dried and then cured by irradiation with a mercury lamp for 15 minutes. Since AQ-2,6-DS is not soluble in an organic solvent, the sulfonic acid group of the AQ-2,6-DS was previously converted into a sulfonyl chloride, and the sulfonyl chloride was mixed with the resin and used.

The experimental results are shown in Table 7. It would be understood that the average current generated during the measuring period with the anode of the porous graphite immobilized with AQ-2,6-DS by a sulfonamide bonding was about 6.9 times higher than the average current generated with the anode immobilized with the use of the ultraviolet curing resin. It can be thought that when AQ-2,6-DS was mixed with the ultraviolet curable resin and coated on the electrode surface (Control), part of the AQ-2,6-DS embedded in the resin layer could not be efficiently brought into contact with the enzyme of the microorganisms or the outer cell released electron mediator (a menaquinone derivative and the like), and accordingly the current value was lowered compared to the formation of a sulfonamide bonding on the electrode surface.

TABLE 7
Results of Power Generation Test

| | Average | | |
|---|---|---|---|
| | Current | Average | Average |
| | Generated | Voltage | Output |
| Experimental System | (mA) | (mV) | (mW) |
| AQ-2, 6-DS sulfonamide | 2.98 × 10² | 320 | 95.36 |
| immobilized onto electrode | | | |
| (Example 3) | | | |
| AQ-2, 6-DS & ultraviolet | 4.31 × 10¹ | 342 | 14.74 |
| curable resin immobilized | | | |
| onto electrode (Control) | | | |

### Example 4

The power generation performance was compared when the generating electric power apparatus for experiment shown in FIG. 5 was used and the electron mediator (AQ-2,6-DS) was immobilized on to the electrode (porous graphite) by a sulfonamide bonding (Example 4) and without adding any electron mediator, non-modified porous graphite was used (Control). The experimental conditions other than the constitution of the power generation unit and the electrode were the same as in Example 1. In the control study, 0.5 g of the Shewanella putrefacience (ATTC No. 51753) bacteria for culturing of sulfur-reducing bacteria known as the microorganisms which perform electrolytic oxidation without any electron mediator was added instead of the anaerobic microorganism integrated culture. For two days after initiating the operation, no liquid was allowed to flow to wait the attachment of the microorganisms to the anode compartment (microbial reaction chamber), and the Trypticase Soy Broth medium (Trypticase Soy Broth, Wako Pure, 30 g/L) of ATTC medium #18 was filled on the anode compartment (microbial reaction chamber) side to accelerate the proliferation of the Shewanella putrefacience bacteria and its adhesion to the electrode.

The experimental results are shown in Table 8. It would be understood that the average current generated during the measuring period with the anode of the porous graphite immobilized with AQ-2,6-DS by a sulfonamide bonding was about 270 times higher than the average current generated with the case that non-modified porous graphite was used without adding an electron mediator and the Shewanella putrefacience bacterial were added. It is recognized from this result that even with the use of microorganisms which were regarded to perform electrolytic reaction without any electron mediator, the quantity of the current generated was remarkably smaller than that when an appropriate electron mediator was immobilized on to the electrode surface.

TABLE 8
Results of Power Generation Test

| | Generated | | |
|---|---|---|---|
| | Current | Average | Average |
| | Generated | Voltage | Output |
| Experimental System | (mA) | (mV) | (mW) |
| AQ-2, 6-DS sulfonamide | 2.98 × 10² | 320 | 95.36 |
| immobilized onto | | | |
| electrode (Example 4) | | | |
| Non-modified electrode, | 1.1 | 410 | 0.451 |
| Shewanella putrefacience | | | |
| added (Control) | | | |

### Example 5

In the system using the generating electric power apparatus for experiment shown in FIG. 5 and a porous graphite plate as the electrically conductive base material of the anode, the power generation performance with anodes immobilized with electron mediators having different standard electrode potentials was compared.

As the pretreatment of an anode, an electrically conductive base material (porous graphite) was connected to the opposite electrode (cathode) through a power source apparatus, dipped in a 20% sulfuric acid solution and subjected to electrolytic oxidation reaction at a current density of the electrode as an anode of 30 to 60 mA/cm² for 30 minutes to one hour. By this pretreatment, a carboxyl group and a hydroxyl group were introduced to the surface of the graphite. The amount of the carboxyl group introduced can be estimated, for example, by measuring the amount of sodium hydrogencarbonate consumed.

In Experiment 1, Control 1 and Control 2, the above carboxyl group-introduced graphite was further reacted with a diamine to introduce an amino group thereinto. Specifically, the carboxyl group-introduced graphite plate was dipped in dichloromethane, and oxalylchloride in an amount of about 100 times the mole of the introduced carboxyl group and a several drops of dimethylformamide were added thereto and the resulting mixture was reacted at room temperature for about four hours with stirring to convert the above described carboxyl group to an acid chloride. Thereafter, the porous graphite plate was washed with dichloromethane, dried and transferred into a tetrahydrofuran solvent. Thereto, 1,3-propanediamine in an amount of about 100 times the mole of the acid chloride was added and the resulting mixture was reacted at room temperature for 12 hours with stirring to introduce an amino group thereinto.

To the amino group-introduced porous graphite plate, anthraquinone-2,6-disulfonic acid (AQ-2,6-DS, E₀′=−185 mV), Indigo Carmine (E₀′=−125 mV) and 5-hydroxy-1,4-naphthoquinone (5-H-1,4-NQ, E₀′=−3 mV) were immobilized in Experiment 1, Control 1 and Control 2, respectively, and used as anodes.

In Experiment 2 and Control 3, the amino group-introduced porous graphite plate as such was used and 2-methyl-5-amino-1,4-naphthoquinone (2-M-5-A-1,4-NQ, E₀′=−140 mV) and Neutral Red (E₀′=−325 mV) were immobilized, respectively.

Experiment 1

In Experiment 1, AQ-2,6-DS which was previously converted into a sulfonyl chloride by the following method was used. One mole of AQ-2,6-DS was reacted in four moles of sulfolane and 4 times moles of a phosphorus oxychloride solvent at 70° C. for 24 hours to convert the sulfonic acid group into a sulfonyl chloride. This product was cooled, filtered, washed with ice-water, thereafter washed with methanol and dried to obtain a yellow powder of AQ-2,6-DS chloride. With the prepared AQ-2,6-DS chloride, the size of the peak of the sulfonyl chloride by FTIR (from 1360 cm⁻¹ to 1380 cm⁻¹) and the purity by the elemental analysis were confirmed.

The amino group-introduced graphite plate (electrically conductive base material) was dipped in tetrahydrofuran and the AQ-2,6-DS chloride obtained in the above described method was added thereto in excess amount based on the amino group of the sulfonyl chloride with slowly stirring and the mixture was further reacted in the presence of triethylamine in an amount of 5 times the mole of the already added sulfonyl chloride at room temperature for about 12 hours to form a sulfonamide bonding between the graphite and the electron mediator. The obtained product was washed with methanol and thereafter was reacted with water for 24 hours or more and then dried to obtain an anode for bioelectrohgenis of this invention which was used as the anode of the biological generating electric power apparatus in FIG. 5.

Experiment 2

The carboxyl group-introduced graphite was dipped in dimethylforamide, and 2-methyl-5-amino-1,4-naphthoquinone (2-M-5-A-1,4-NQ) was added thereto in excess amount (100 mol % or more) based on the carboxyl group with slowly stirring and reacted in the presence of dicyclohexylcarbodiimide at room temperature for 72 hours to form an amide bonding between the amino group of 2-M-5-A-1,4-NQ and the carboxyl group on the surface of the graphite and thus the electron mediator was immobilized. The obtained product was washed with dimethylformaide, then with methanol and dried to obtain an anode for generating electric power of this invention which was used as the anode 1 of the above described biological generating electric power apparatus in FIG. 5.

Control 1

In Control 1, Indigo Carmine which had been previously converted to a sulfonyl chloride was used.

One mole of Indigo Carmine was reacted in a solvent of 4 moles of sulfolane and 4 times moles of phosphorus oxychloride at 70° C. for 24 hours to convert the sulfonic acid group into a sulfonyl chloride. This sulfonyl chloride was cooled, filtered, washed with ice water and then dried to obtain a blue powder of Indigo Carmine chloride.

The amino group-introduced graphite plate (electrically conductive base material) was dipped in tetrohydrofuran, and the above described Indigo Carmine chloride was added thereto in excess amount (100 mol % or more) based on the amino group with slowly stirring. The resulting mixture was reacted in the presence of triethylamine in an amount of 5 times the mole of the added Indigo Carmine chloride at room temperature for about 12 hours to introduce an electron mediator by forming a sulfonamide bonding between the amino group and the Indigo Carmine chloride. The obtained product was washed with methanol, then with water and dried to obtain an anode for generating electric power which was used as the anode 1 of the generating electric power apparatus in FIG. 5.

Control 2

In Control 2, 5-H-1,4-NQ which had been previously converted into a sulfonyl chloride was used.

In 100 mL of a 20% (v/v) chlorosulfonic acid/dichloro-methane solution, 5 g of 5-H-1,4-NQ manufactured by Aldrich was dissolved and reacted in the presence of 2 mL of concentrated sulfuric acid to introduce a sulfonyl chloride group.

The amino group-introduced graphite plate (electrically conductive base material) was dipped in tetrohydrofuran, and the above described 5-H-1,4-NQ sulfonyl chloride was added thereto in excess amount (100 mol % or more) based on the amino group with slowly stirring. The resulting mixture was reacted in the presence of triethylamine in an amount of 5 times the mole of the added 5-H-1,4-NQ sulfonyl chloride at room temperature for about 12 hours to introduce an electron mediator by forming a sulfonamide bonding between the hydrophilic polymer and the 5-H-1,4-NQ. The obtained product was washed with methanol and dried to obtain an anode for generating electric power which was used as the anode 1 of the generating electric power apparatus in FIG. 5.

Control 3

The carboxyl group-introduced porous graphite plate (electrically conductive base material) was dipped in dimethylformamide and Neutral Red was added thereto in excess amount (100 mol % or more) based on the carboxyl group with slowly stirring and the resulting mixture was reacted in the presence of dicyclohexycarbodiimide at room temperature for about 72 hours to immobilize an electron mediator by forming an amide bonding between the amino group of Neutral Red and the carboxyl group of the surface of the graphite. The obtained product was washed with dimethylformamide, then with methanol and dried to obtain an anode for generating electric power which was used as the anode 1 of the generating electric power apparatus in FIG. 5.

<Power Generation Performance>

With the use of the anodes obtained Experiments 1 and 2 and Controls 1 and 2 in Example 5 and the generating electric power apparatus shown in FIG. 5, power generation tests were performed. The experimental conditions other than the constitution of the substrate solution and the electrode are the same as in Example 1.

As the substrate solution, the model of a water-containing organic substance (prepared by mixing 0.01 g/L of a yeast extract with 0.1 mol/L of a glucose solution) was used. For 10 days after the initiation of operation, the liquid was not passed to wait the adhesion of microorganisms to the inside of an anaerobic region (biological reaction chamber), and thereafter the Desulfuromonas medium shown in Table 4 was packed on the side of the anaerobic region (biological reaction chamber) to accelerate the dominance of the sulfur-reducing bacteria. Ten days after the initiation of operation, fixing operation with a residence time of the substrate solution of two days was performed and 20 days after the initiation of operation, the normal operation with a residence time in the anaerobic region of 500 minutes was performed and the quantity of current and the voltage between the anode and the cathode were measured. Further, the supply of air to the aerobic region had a residence time of 0.5 minute. The results of the power generation tests are shown in Table 9.

TABLE 9

| | | Standard | | | |
|---|---|---|---|---|---|
| | | Electrode | | | |
| | | Potential | | | |
| | Electron | Eₒ′ of | Average | | |
| | Mediator | Electron | Current | Average | Average |
| Experimental | Immobilized | Mediator | Generated | Voltage | Output |
| System | on to Anode | (V) | (mA) | (mV) | (mW) |
| Experiment 1 | AQ-2,6-DS | −0.185 | 84 | 370 | 31.08 |
| Experiment 2 | 2-M-5-A- | −0.140 | 41 | 295 | 12.10 |
| | 1,4-NQ | | | | |
| Control 1 | Indigo | −0.125 | 1.2 | 250 | 0.30 |
| | Carmine | | | | |
| Control 2 | 5-H-1,4-NQ | −0.003 | 12 | 240 | 2.88 |
| Control 3 | Neutral Red | −0.325 | 1.8 | 380 | 0.68 |

It could be understood from the generated electrical output that the standard electrode potentials E₀′ of the electron mediators immobilized on to anodes in the range of −0.13 to −0.28 V (Experiments 1 and 2) were higher than those outside that range (Controls 1, 2 and 3), and generated about 4 to 100 times higher electric power.

Further, when Experiment 1 was compared with Experiment 2, Experiment 1 showed about 2.6 times higher output than Experiment 2 and it can be thought that this was the cause of the electron mediator immobilized onto the anode of Experiment 1 having a standard electrode potential range of −0.25 to −0.15 V while the electron mediator immobilized onto the anode of Experiment 2 having a standard electrode potential range of as slightly higher as −0.15 to −0.13 V. From this fact it can be understood that electrodes immobilized with electron mediators having a standard electrode potential range of −0.15 to −0.28 V, preferably −0.15 to −0.27 V is advantageous from the standpoint of power generation.

### INDUSTRIAL UTILIZATION

As explained above, this invention enables efficient oxidation decomposition of a water-containing organic substance such as waste water, waste liquor, nightsoil, food waste and other organic wastes or their decomposed products to obtain more electrical energy than the conventional microbial fuel cells. It is expected that this invention is broadly utilized as a power generation method utilizing the oxidation decomposition of the water-containing organic substance and reduction potential.

What is claimed is:

1. A method of generating electric power comprising:
forming a closed circuit by electrically connecting an anode formed by immobilizing an electron mediator having a standard electrode potential (E₀′) at pH 7 in the range of −0.13 V to −0.28 V on an electrode and a cathode;
bringing said anode into contact with microorganisms capable of growing under anaerobic conditions and a solution or suspension containing organic substances to advance the oxidation reaction by the microorganisms using said organic substances as an electron donor;
advancing the reduction reaction using oxygen as an electron acceptor at said cathode isolated from said solution or suspension through an electrolyte membrane; and
accelerating the oxidation reaction in the biological system to generate power.

2. The method of claim 1, wherein the electron mediator is selected from the group consisting of anthraquinone derivatives, naphthoquinone derivatives, azobenzene derivatives and isoalloxazine derivatives.

3. The method of claim 1, wherein said electron mediator is selected from the group consisting of anthraquinone-2-carboxylic acid (AQC), anthraquinone-2-sulfonic acid (AQS), anthraquinone-2,6-disulfonic acid (AQ-2,6-DS), anthraquinone-2,7-disulfonic acid (AQ-2,7-DS), anthraquinone-1,5-disulfonic acid (AQ-1,5-DS), lapachol (LpQ), flavin mononucleotide (FMN) and their derivatives.

4. The method of claim 1, wherein said electron mediator is chemically bonded to the surface of said electrode.

5. The method of claim 1, wherein said microorganisms are microorganisms or a microbial consortium containing at least sulfur-reducing bacteria.

6. The method of claim 1, wherein said anode is constituted of an electrode material selected from the group consisting of graphite, porous graphite, gold, platinum and metal oxides or an electrode material coated with a metal oxide.

7. The method of claim 1, wherein said cathode is formed of an electrically conductive porous material at least a part of which has a void in its structure or an electrically conductive network or fibrous material, and the cathode contacts with air in such a state that the contact interface between the air and the water exists in the void of said cathode.

8. The method of claim 1, wherein said cathode carries a catalyst comprising an alloy or a compound containing at least one element selected from platinum family elements, silver and transition metal elements.

9. The method of claim 1, wherein said electrolyte membrane is a cation-exchange membrane or an anion-exchange membrane.

10. A method of generating electric power comprises: forming a closed circuit by electrically connecting an anode formed by immobilizing an electron mediator selected from the group consisting of anthraquinone-2-carboxylic acid (AQC), anthraquinone-2-sulfonic acid (AQS), anthraquinone-2,6-disulfonic acid (AQ-2,6-DS), anthraquinone-2,7-disulfonic acid (AQ-2,7-DS), anthraquinone-1,5-disulfonic acid (AQ-1,5-DS), lapachol (LpQ), flavin mononucleotide (FMN) and their derivatives on an electrode and a cathode;
bringing said anode into contact with microorganisms capable of growing under anaerobic conditions and a solution or suspension containing organic substances to advance the oxidation reaction by the microorganisms using said organic substances as an electron donor;
advancing the reduction reaction using oxygen as an electron acceptor at said cathode isolated from said solution or suspension through an electrolyte membrane; and
accelerating the oxidation reaction in the biological system to generate power.

11. The method of claim 10, wherein said electron mediator is chemically bonded to the surface of said electrode.

12. The method of claim 10, wherein said microorganisms are microorganisms or a microorganism consortium containing at least sulfur-reducing bacteria.

13. The method of claim 10, wherein said anode is constituted of an electrode material selected from the group consisting of graphite, porous graphite, gold, platinum and metal oxides or an electrode material coated with a metal oxide.

14. The method of claim 10, wherein said cathode is formed of an electrically conductive porous material at least a part of which has a void in its structure or an electrically conductive network or fibrous material, and the cathode contacts with air in such a state that the contact interface between the air and the water exists in the void of said cathode.

15. The method of claim 10, wherein said cathode carries a catalyst comprising an alloy or a compound containing at least one element selected from platinum family elements, silver and transition metal elements.

16. The method of claim 10, wherein said electrolyte membrane is a cation-exchange membrane or an anion-exchange membrane.

17. A generating electric power apparatus having an anode compartment and a cathode compartment partitioned by an electrolyte membrane, wherein the anode compartment has an anode on to which an electron mediator having a standard electrode potential (E₀′) of −0.13 V to −0.28 V is immobilized, microorganisms capable of growing under anaerobic conditions and a feed mechanism and a discharge mechanism for a solution or suspension containing organic substances, and the cathode compartment has a cathode and a feed mechanism and a discharge mechanism for oxygen or air.

18. The generating electric power apparatus of claim 17, wherein said electron mediator is selected from the group consisting of anthraquinone-2-carboxylic acid (AQC), anthraquinone-2-sulfonic acid (AQS), anthraquinone-2,6-disulfonic acid (AQ-2,6-DS), anthraquinone-2,7-disulfonic acid (AQ-2,7-DS), anthraquinone-1,5-disulfonic acid (AQ-1,5-DS), lapachol (LpQ), flavin mononucleotide (FMN) and their derivatives.

19. The generating electric power apparatus of claim 17, wherein said anode is constituted of an electrode material selected from the group consisting of graphite, porous graphite, gold, platinum and metal oxides or an electrode material coated with a metal oxide.

20. The generating electric power apparatus of claim 17, wherein said cathode is constituted of an electrically conductive porous material at least a part of which has a void in its structure or an electrically conductive network or fibrous material and is arranged in contact with said electrolyte membrane.

21. The generating electric power apparatus of claim 17, wherein said cathode carries a catalyst comprising at least one element selected from platinum family elements, silver and transition metal elements.

22. The generating electric power apparatus of claim 17, wherein said electrolyte membrane is a cation-exchange membrane or an anion-exchange membrane.

23. The generating electric power apparatus of claim 17, wherein a plurality of a combination of the anode compartments and the cathode compartments partitioned by the electrolyte membrane are laminated.

24. A generating electric power apparatus having an anode compartment and a cathode compartment partitioned by an electrolyte membrane, wherein the anode compartment has an anode on to which an electron mediator selected from the group consisting of anthraquinone-2-carboxylic acid (AQC), anthraquinone-2-sulfonic acid (AQS), anthraquinone-2,6-disulfonic acid (AQ-2,6-DS), anthraquinone-2,7-disulfonic acid (AQ-2,7-DS), anthraquinone-1,5-disulfonic acid (AQ-1,5-DS), lapachol (LpQ), flavin mononucleotide (FMN) and their derivatives is immobilized, microorganisms capable of growing under anaerobic conditions and a feed mechanism and a discharge mechanism for a solution or suspension containing an organic substance, and the cathode compartment has a cathode and a feed mechanism and a discharge mechanism for oxygen or air.

25. The generating electric power apparatus of claim 24, wherein said anode is constituted of an electrode material selected from the group consisting of graphite, porous graphite, gold, platinum and metal oxides or an electrode material coated with a metal oxide.

26. The generating electric power apparatus of claim 24, wherein said cathode is constituted of an electrically conductive porous material or an electrically conductive net or fibrous material, at least a part of which has a void in its structure and is arranged in contact with said electrolyte membrane.

27. The generating electric power apparatus of claim 24, wherein said cathode carries a catalyst comprising an alloy or a compound containing at least one element selected from platinum family elements, silver and transition metal elements.

28. The generating electric power apparatus of claim 24, wherein said electrolyte membrane is a cation-exchange membrane or an anion-exchange membrane.

29. The generating electric power apparatus of claim 24, wherein a plurality of a combination of the anode compartment and the cathode compartment partitioned by said electrolyte membrane are laminated.
